(19) United States
(12) Patent Application Publication
(10) Pub. No.: US 2026/0326485 A1
(43) Pub. Date: Oct. 22, 2026

(54) PNEUMATIC TIRE

(71) Applicant: TOYO TIRE CORPORATION, Itami-shi (JP)

(72) Inventor: Tsuyoshi FUJIOKA, Itami-shi (JP)

(73) Assignee: TOYO TIRE CORPORATION, Itami-shi (JP)

(21) Appl. No.: 19/652,362

(22) Filed: Apr. 20, 2026

(30) Foreign Application Priority Data
Apr. 21, 2025 (JP) 2025-069321
Apr. 21, 2025 (JP) 2025-069322

(51) Int. Cl. B60C 11/03; B60C 11/12

(52) U.S. Cl. CPC B60C 11/0306; B60C 11/1236; B60C 11/1259; B60C 2011/0339

(57) ABSTRACT

A pneumatic tire capable of maintaining winter performance while suppressing uneven wear of shoulder lands. A pneumatic tire includes a pair of shoulder lands each including: first slits, second slits, first land constricted portions that are provided inward in the tire axial direction with respect to the first slits and are narrower than a maximum width of the shoulder land, second land constricted portions that are provided inward in the tire axial direction with respect to the second slits, first notches that open to a first shoulder main groove and are arranged such that the first land constricted portions are interposed between the first notches and the first slits, and second notches that open to the first shoulder main groove and are arranged such that the second land constricted portions are interposed between the second notches and the second slits.

This application is based on and claims the benefit of priority from Japanese Patent Application No. 2025-069321, filed on 21 Apr. 2025, and Japanese Patent Application No. 2025-069322, filed on 21 Apr. 2025, the contents of which are incorporated herein by reference.

### FIELD

The present disclosure relates to a pneumatic tire.

### BACKGROUND

Studless winter tires having winter performance are known. For example, Japanese Unexamined Patent Application, Publication No. 2012-250610 discloses a tire having a plurality of blocks as tread lands defined by main grooves and slits, and sipes formed in the blocks. Winter performance is enhanced by edge effects and water removal effects of the sipes, and further enhanced by traction effects of the slits.

### SUMMARY

However, the blocks as the tread lands tend to separate from each other and move, which increases the likelihood of uneven wear. When uneven wear progresses, the ground contact performance of the ground contact surface of the tire with respect to a road surface deteriorates, and winter performance is lowered. In particular, tire shoulders are susceptible to lateral force. For example, when the tire is turned, most of the lateral force inputted to the tire acts on the shoulders. Therefore, shoulder blocks are most susceptible to uneven wear.

It is an object of the present invention to provide a pneumatic tire capable of maintaining performance while suppressing uneven wear of shoulder lands.

It is an object of the present invention to provide a pneumatic tire capable of maintaining performance while suppressing uneven wear of shoulder lands up to a middle stage of wear.

A pneumatic tire according to one aspect of the present invention is
a tire having a tread,
the tread including:
four main grooves extending in a tire circumferential direction; and
lands defined in a tire axial direction by the four main grooves, the lands including a center land, a pair of shoulder lands, and a pair of intermediate lands one of which is disposed between the center land and one of the pair of shoulder lands, and the other of which is disposed between the center land and the other of the pair of shoulder lands,
each of the pair of shoulder lands including:
a plurality of first slits that each extend from a ground contact end of the tread, pass through a land width center, and reach a location inward in the tire axial direction;
a plurality of second slits that are arranged alternately with the plurality of first slits in the tire circumferential direction, and extend inward in the tire axial direction from the ground contact end of the tread, the plurality of second slits having a narrower groove width than the plurality of first slits;
a plurality of first land constricted portions that are provided inward in the tire axial direction with respect to the first slits and are narrower than a maximum width of the shoulder land;
a plurality of second land constricted portions that are provided inward in the tire axial direction with respect to the second slits;
a plurality of first notches that open to one of the main grooves and are arranged such that the plurality of first land constricted portions are interposed between the plurality of first notches and the plurality of first slits; and
a plurality of second notches that open to the one of the main grooves and are arranged such that the plurality of second land constricted portions are interposed between the plurality of second notches and the plurality of second slits.

A pneumatic tire according to one aspect of the present invention is
a tire having a tread,
the tread including:
four main grooves extending in a tire circumferential direction; and
lands defined in a tire axial direction by the four main grooves, the lands including a center land, a pair of shoulder lands, and a pair of intermediate lands one of which is disposed between the center land and one of the pair of shoulder lands, and the other of which is disposed between the center land and the other of the pair of shoulder lands,
the shoulder lands including sipes. A shoulder land sipe density, which is a value obtained by dividing a sum of lengths of the sipes in the shoulder lands by an area of the shoulder lands, is defined as 100% in an unused state in which the pneumatic tire is unused,
when a tire surface is worn by 15% with respect to a depth of the main grooves that is defined as 100% in the unused state, the shoulder land sipe density is 60% or more and 80% or less with respect to the shoulder land sipe density in the unused state; and
when the tire surface is worn by 50% with respect to the depth of the main grooves that is defined as 100% in the unused state, the shoulder land sipe density is 35% or more and 55% or less with respect to the shoulder land sipe density in the unused state.

A pneumatic tire according to another aspect of the present invention is
a tire having a tread,
the tread including:
four main grooves extending in a tire circumferential direction; and
lands defined in a tire axial direction by the four main grooves, the lands including a center land, a pair of shoulder lands, and a pair of intermediate lands one of which is disposed between the center land and one of the pair of shoulder lands, and the other of which is disposed between the center land and the other of the pair of shoulder lands,
the shoulder lands having sipes. A shoulder land sipe density, which is a value obtained by dividing a sum of lengths of the sipes in the shoulder lands by an area of the shoulder lands, is:
0.055 mm/mm² or more and 0.075 mm/mm² or less in an unused state in which the pneumatic tire is unused;
surface is worn by 15% with respect to a depth of the main grooves that is defined as 100% in the unused state; and
0.020 mm/mm² or more and 0.040 mm/mm² or less when the tire surface is worn by 50% with respect to the depth of the main grooves that is defined as 100% in the unused state.

The present invention can provide a pneumatic tire capable of maintaining winter performance while suppressing uneven wear of shoulder lands.

The present invention can provide a pneumatic tire capable of maintaining winter performance while suppressing uneven wear of shoulder lands until a middle stage of wear.

### BRIEF DESCRIPTION OF THE DRAWINGS

FIG. 1 is a development view illustrating a tread surface of a pneumatic tire according to a first embodiment;

FIG. 2 is a partially enlarged view of FIG. 1, and is a development view illustrating a shoulder land;

FIG. 3 is a cross-sectional view taken along line III-III in FIG. 1 and illustrating a first slit;

FIG. 4 is a development view illustrating a tread surface at 15% tire wear;

FIG. 5 is a development view illustrating a tread surface at 50% tire wear;

FIG. 6 is a development view illustrating a tread surface at 66% tire wear; and

FIG. 7 is a development view illustrating a tread surface at 75% tire wear.

### DETAILED DESCRIPTION OF THE EMBODIMENTS

### First Embodiment

### Basic Structure of Pneumatic Tire

Embodiments of the present invention will be described below in detail with reference to the accompanying drawings. In the following embodiments, the same components are denoted by the same reference signs in the drawings, and redundant description is omitted. The drawings include schematic diagrams, and dimensional ratios between vertical and horizontal dimensions, height, etc. of each component are not necessarily the same in different drawings. Further, in the pneumatic tire 1 described below, the left and right halves with a tire equatorial plane CL as a boundary have the same structure. However, the left and right halves of the pneumatic tire with the tire equatorial plane CL as a boundary may have different structures. The dimensions of the grooves of the pneumatic tire 1 described below are those of the pneumatic tire 1 in an unused state and free of wear.

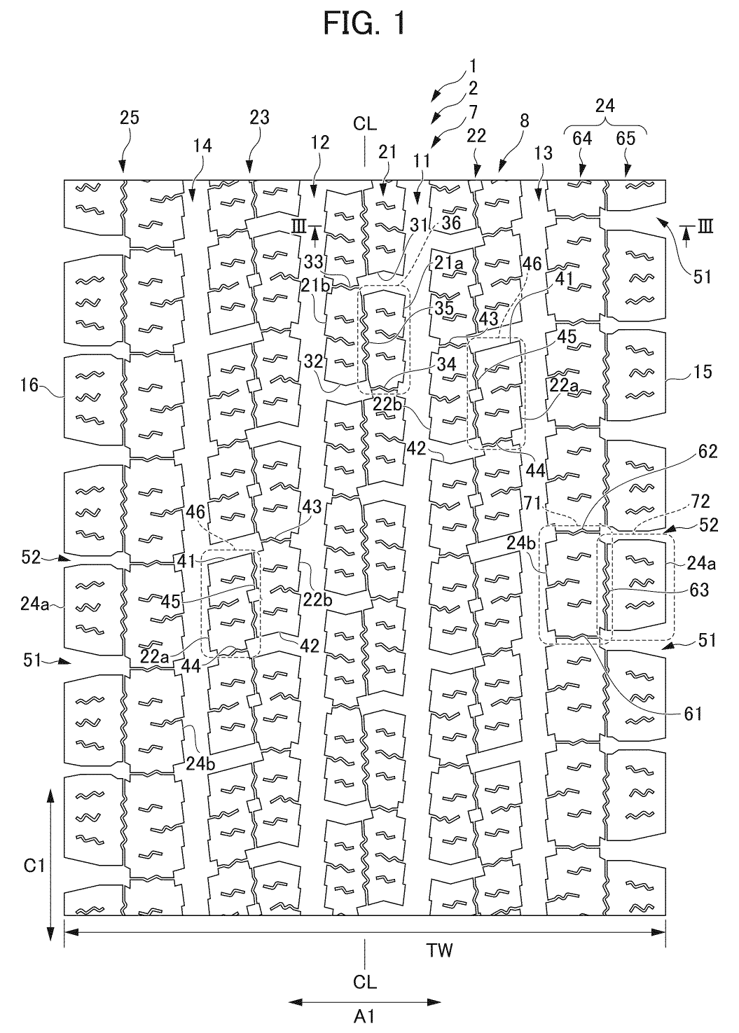

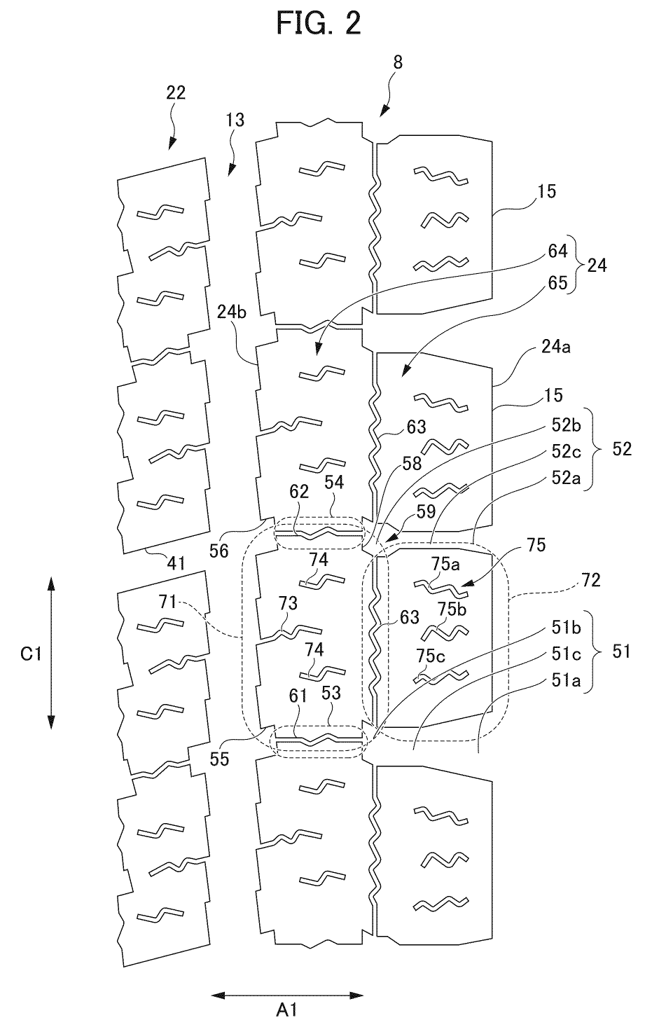

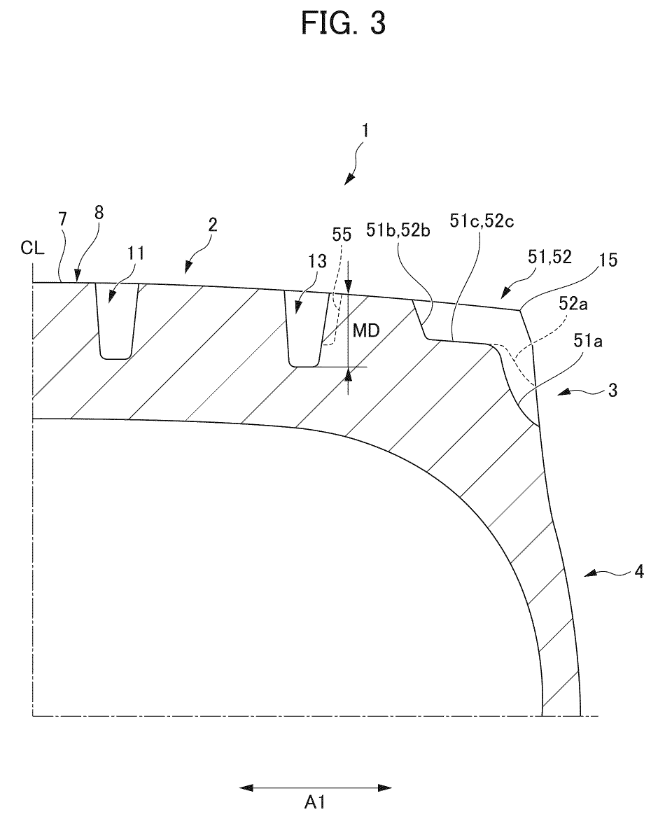

A basic structure of the pneumatic tire 1 (hereinafter simply referred to as the tire 1) will be described with reference to FIGS. 1 to 3. FIG. 1 is a developed view illustrating a tread surface 7 of the tire 1 according to the first embodiment. FIG. 2 is a partially enlarged view of FIG. 1, and is a developed view of a first shoulder land 24. FIG. 3 is a cross-sectional view taken along line III-III in FIG. 1 and illustrates a first slit 51. In the present specification, a slit refers to a groove that is narrower than a main groove and wider than a sipe. The sipe refers to a groove having a width of less than 1.5 mm.

The tire 1 is a heavy load-carrying tire that is fitted to a heavy vehicle, such as a truck, a bus, and the like. The tire 1 has a general configuration that is employed to pneumatic tires. Specifically, as illustrated in FIG. 3, the tire 1 includes a tread 2, shoulders 3, sidewalls 4, and beads (not illustrated). The tread 2 has a tread surface 7 that comes into direct contact with a road surface, and the tread surface 7 has a tread pattern 8 engraved therein. In the following, the positional relationships of components is described using an "axial direction A1" and a "circumferential direction C1". The axial direction A1 is along a rotation axis of the tire 1 and coincides with a width direction of the tire. The circumferential direction C1 is along a rotation direction of the tire 1. In the following description, the "width" of a groove, a slit, and a sipe refers to the maximum width thereof.

The shoulders 3 are a pair of shoulder portions located outward of the tread 2 in the axial direction A1, and the sidewalls 4 are located inward of the shoulders 3 in a radial direction. Each bead includes a bead core and a bead filler, and has a structure in which high-carbon steel wires are bundled, for example. The aforementioned tread surface 7 is a surface that comes into contact with a flat road surface when a normal load is applied to the tire in a state of being fitted on a regular rim, filled to a regular internal pressure, and placed perpendicularly to the flat road surface. The tread surface 7 has a first ground contact end 15 and a second ground contact end 16, which are disposed at outermost positions in the axial direction A1.

The tread 2, the shoulders 3, and the sidewalls 4 protect a carcass (not shown) that is stretched from the bead on one side to the bead on the other side in the axial direction A1. The beads play a role of fixing the opposite ends of the carcass and fixing the tire 1 to a rim. A belt (not shown) is provided on a radially outer side of the carcass, and a tread rubber is provided on a radially outer side of the belt. An inner liner (not shown) is provided inward of the carcass.

### Outline of Tread Pattern 8

As illustrated in FIG. 1, the tread surface 7 of the tire 1 of the present embodiment includes four main grooves each extending continuously in the circumferential direction C1 and five land rows defined by the four main grooves. In other words, the tread pattern 8 is a ribbed pattern in which the land rows extend continuously in the circumferential direction C1.

The four main grooves include a first center main groove 11, a second center main groove 12, a first shoulder main groove 13, and a second shoulder main groove 14.

The first center main groove 11 and the second center main groove 12 are provided in a center portion in the axial direction A1 of the tread surface 7, extend over the entire circumference in the circumferential direction C1, and are arranged on left and right sides of the tire equatorial plane CL.

The first shoulder main groove 13 and the second shoulder main groove 14 are provided on the tread surface 7 such that the first center main groove 11 and the second center main groove 12 are interposed in the axial direction A1, and extend over the entire circumference in the circumferential direction C1. Specifically, the first shoulder main groove 13 is located outward of the first center main groove 11 in the axial direction A1. The second shoulder main groove 14 is located outward of the second center main groove 12 in the axial direction A1. The first shoulder main groove 13 and the second shoulder main groove 14 are disposed substantially plane-symmetrically with respect to the tire equatorial plane CL.

The five land rows include a center land 21 between the first center main groove 11 and the second center main groove 12, a first intermediate land 22 between the first center main groove 11 and the first shoulder main groove 13, a second intermediate land 23 between the second center main groove 12 and the second shoulder main groove 14, a first shoulder land 24 between the first shoulder main groove 13 and the first ground contact end 15, and a second shoulder land 25 between the second shoulder main groove 14 and the second ground contact end 16. Hereinafter, the length of each land in the axial direction is referred to as a land width.

Each of the first shoulder land 24, the second shoulder land 25, the first intermediate land 22, and the second intermediate land 23 has a larger land width than the center land 21. Each of the first shoulder land 24 and the second shoulder land 25 has a larger land width than the first intermediate land 22 and the second intermediate land 23. Due to this configuration in which the land widths increase toward the first shoulder land 24 and the second shoulder land 25, rigidity is increased, whereby uneven wear (shoulder wear) of the first shoulder land 24 and the second shoulder land 25 can be prevented or reduced.

Specifically, the land width of each of the first intermediate land 22 and the second intermediate land 23 is 105% or more and 125% or less of the land width of the center land 21. The land width of each of the first shoulder land 24 and the second shoulder land 25 is 130% or more and 160% or less of the land width of the center land 21.

The length in the tire axial direction of each of the first shoulder land 24 and the second shoulder land 25 is 10% or more and 30% or less of a tread ground contact width TW. Since the length is 10% or more, the first shoulder land 24 and the second shoulder land 25 have high rigidity, and uneven wear is less likely to occur. Further, since the length is 30% or less, the center land 21, the first intermediate land 22, and the second intermediate land 23 have high rigidity, and uneven wear is less likely to occur.

### Details of Center Land 21

As illustrated in FIG. 1, the center land 21 is provided along the tire equatorial plane CL. The center land 21 has a plurality of first slits 31 and a plurality of second slits 32. The first slits 31 and the second slits 32 are alternately arranged in the circumferential direction C1.

Each first slit 31 opens to the first center main groove 11 at a land end 21a on a first side in the axial direction A1, is spaced apart from a land end 21b on a second side in the axial direction A1, and is closed within the center land 21. Each second slit 32 opens to the land end 21b on a second side in the axial direction A1, is spaced apart from the land end 21a on the first side in the axial direction A1, and is closed within the center land 21. The length of each of the first slits 31 and the second slits 32 in the axial direction A1 is 40% or more, and more preferably 50% or more, of the maximum width of the center land 21 in the axial direction A1.

Next, sipes formed in the center land 21 will be described. First axial sipes 33 extend in the axial direction A1 and each divide a land portion of the center land 21 located on one side in the axial direction of the corresponding first slit 31. Second axial sipes 34 extend in the axial direction A1 and each divide a land portion of the center land 21 located on one side in the axial direction of the corresponding second slit 32. Circumferential sipes 35 extend in the circumferential direction C1 in a widthwise center portion of the center land 21 and connect the first slits 31 and the second slits 32 that are alternately arranged in the circumferential direction C1. Specifically, the circumferential sipes 35 extend in the circumferential direction C1 to open to both the first and second slits 31 and 32, and divide the center land 21 into two portions adjacent in the axial direction A1. The first slits 31, the second slits 32, the first axial sipes 33, the second axial sipes 34, and the circumferential sipes 35 divide the center land 21 to define a plurality of center land blocks 36.

### First Intermediate Land 22 and Second Intermediate Land 23

The configuration of the first intermediate land 22 will be described below. Because the configuration of the second intermediate land 23 is the same as that of the first intermediate land 22, the description of the second intermediate land 23 will be omitted.

The first intermediate land 22 has a plurality of first slits 41 and a plurality of second slits 42. Each first slit 41 opens to the first shoulder main groove 13 at a land end 22a on the first side in the axial direction A1, is spaced apart from a land end 22b on the second side in the axial direction A1, and is closed within the first intermediate land 22. Each second slit 42 opens to the first center main groove 11 at the land end 22b on the second side in the axial direction A1, is spaced apart from the land end 22a on the first side in the axial direction A1, and is closed within the first intermediate land 22. The first slits 41 and the second slits 42 are alternately arranged in the circumferential direction C1. The length of each of the first slits 41 and the second slits 42 in the axial direction A1 is 40% or more, and more preferably 50% or more of the maximum width of the first intermediate land 22 in the axial direction A1.

Next, sipes formed in the first intermediate land 22 will be described. First axial sipes 43 extend in the axial direction A1 and each divide a land portion of the first intermediate land 22 located on one side in the axial direction of the corresponding first slit 41. Second axial sipe 44 extend in the axial direction A1 and each divide a land portion of the first intermediate land 22 located on one side in the axial direction of the corresponding second slit 42. Circumferential sipes 45 extend in the circumferential direction C1 in a widthwise center portion of the first intermediate land 22 and connect the first slits 41 and the second slits 42 that are alternately arranged in the circumferential direction C1. Specifically, the circumferential sipes 45 extend in the circumferential direction C1 to open to both the first and second slits 41 and 42, and divide the first intermediate land 22 into two portions adjacent in the axial direction A1. The first slits 41, the second slits 42, the first axial sipes 43, the second axial sipes 44, and the circumferential sipes 45 divide the first intermediate land 22 to define a plurality of intermediate land blocks 46.

### First Shoulder Land 24 and Second Shoulder Land 25

The first shoulder land 24 and the second shoulder land 25 each extend continuously in the circumferential direction C1.

The configuration of the first shoulder land 24 will be described below. Because the configuration of the second shoulder land 25 is the same as that of the first shoulder land 24, the description of the second shoulder land 25 will be omitted.

The first shoulder land 24 has a first land end 24a closer to the first ground contact end 15 and a second land end 24b closer to the first shoulder main groove 13. The second land end 24b has a shape with a plurality of stepped portions.

The first shoulder land 24 has a plurality of first slits 51 and a plurality of second slits 52. The first slits 51 are used for attaching a tire chain. The first slits 51 and the second slits 52 are alternately arranged in the circumferential direction C1. The first slits 51 and the second slits 52 are axial grooves that open to the first ground contact end 15 and are closed within the first shoulder land 24. Because an axially outer portion of the first shoulder land 24 is most susceptible to lateral force, dividing the axially outer portion with the plurality of first slits 51 and second slits 52 leads to mitigation of the lateral force and suppression of uneven wear. Furthermore, alternately arranging the first slits 51 and the plurality of second slits 52 allows for both attaching a tire chain and ensuring block rigidity. Furthermore, an axially inner portion of the first shoulder land 24 has a ribbed shape, which leads to an increase in rigidity and suppression of uneven wear.

### First Shoulder Land 24

The configuration of the first shoulder land 24 will be described in detail with reference to FIG. 2.

### First Slit 51

Each first slit 51 extends from the first ground contact end 15 of the tread surface 7, passes through a land width center, and reaches a location inward in the axial direction. In other words, the length of the first slit 51 in the axial direction A1 is 50% or more of the maximum width of the first shoulder land 24 in the axial direction A1. Specifically, the first slit 51 opens to the first land end 24a (first ground contact end 15), is spaced apart from the second land end 24b (first shoulder main groove 13), and is closed within the first shoulder land 24.

Each first slit 51 has a first opening portion 51a that widens toward the first ground contact end 15, a first closed portion 51b that is closed at the center of the first shoulder land 24, and a first intermediate portion 51c that connects the first opening portion 51a and the first closed portion 51b.

### Second Slit 52

The second slits 52 are alternately arranged with the plurality of first slits 51 in the circumferential direction C1, and extend from the first ground contact end 15 of the tread surface 7, pass through the land width center, and reach a location inward in tire axial direction. In other words, the length of each second slit 52 in the axial direction A1 is 50% or more of the maximum width of the first shoulder land 24 in the axial direction A1. However, the length of each second slit 52 in the axial direction A1 may be less than 50% of the maximum width of the first shoulder land 24 in the axial direction A1. Specifically, each second slit 52 opens to the first land end 24a, is spaced apart from the second land end 24b, and is closed within the first shoulder land 24. The second slits 52 have a narrower groove width than the first slits 51.

Each second slit 52 has a second opening portion 52a that widens toward the first ground contact end 15, a second closed portion 52b that is closed at the center of the first shoulder land 24, and a second intermediate portion 52c that connects the second opening portion 52a and the second closed portion 52b. The second closed portion 52b has a larger width in the circumferential direction than the second intermediate portion 52c. This configuration in which the second closed portion 52b is wider than the second intermediate portion 52c makes it easier to grip snow, thereby improving winter performance. On the other hand, designing the second intermediate portion 52c narrower causes adjacent blocks to come into contact with each other during braking to suppress excessive block deformation, thereby suppressing occurrence of uneven wear.

### Depth and Axial Length of First Slit 51 and Second Slit 52

As illustrated in FIG. 3, in the first slit 51, the first opening portion 51a is deeper than the first intermediate portion 51c. In the second slit 52, the second opening portion 52a is deeper than the second intermediate portion 52c. The first opening portion 51a and the second opening portion 52a each have a depth greater than a main groove depth MD. In particular, the first opening portion 51a of each first slit 51 is deeper than the main groove depth MD in order for a tire chain to be attached thereto.

The first closed portion 51b and the first intermediate portion 51c of the first slit 51 and the second closed portion 52b and the second intermediate portion 52c of the second slit, which are shallow portions, have a depth of 40% or more and 60% or less with respect to the main groove depth MD. As a result, the first slits 51 and the second slits 52 have a depth sufficient up to a middle stage of wear and necessary for achieving winter performance, whereby the rigidity of the clocks can be ensured and uneven wear can be suppressed. Since the above value is 40% or more, a sufficient volume for gripping snow can be ensured, thereby making it possible to maintain snow performance at a high level. Since the above value is 60% or less, the block rigidity is ensured, and uneven wear is suppressed.

The length of each of the first slits 51 and the second slits 52 in the axial direction is preferably 50% or more and 65% or less of the land width of the first shoulder land 24. Since this value is 50% or more, the effect of mitigating lateral force is maintained, and uneven wear (shoulder wear) is less likely to occur. Since this value is 65% or less, the block rigidity is maintained at a high level, whereby the likelihood of occurrence of uneven wear (T/H) and early wear is reduced.

The first closed portion 51b and the second closed portion 52b extend in a direction inclined toward one side in the circumferential direction C1 with respect to the axial direction A1. This configuration in which the first and second closed portions 51b and 52b are inclined in the same direction can eliminate a rigidity difference between the blocks, thereby suppressing occurrence of uneven wear.

### Land Constricted Portions

In the first shoulder land 24, each first slit 51 forms a first land constricted portion 53. In the first shoulder land 24, each second slit 52 forms a second land constricted portion 54. The width of the first land constricted portion 53 in the axial direction is smaller than the maximum width of the first shoulder land 24 in the axial direction. The width of the second land constricted portion 54 in the axial direction is smaller than the maximum width of the first shoulder land 24 in the axial direction. The first land constricted portion 53 and the second land constricted portion 54 are alternately arranged in the circumferential direction C1.

### Notches

The first shoulder land 24 has first notches 55 and second notches 56. The first notches 55 and the second notches 56 open to the first shoulder main groove 13. Each first notch 55 is disposed such that the first land constricted portion 53 is interposed between the first notch 55 and the first slit 51. Each second notch 56 is disposed such that the second land constricted portion 54 is interposed between the second notch 56 and the second slit 52. The first notches 55 and the second notches 56 are structures that ensure traction elements necessary for a studless winter tires to achieve winter performance. Each second notch 56 is formed at a position opposing the first slit 41 of the first intermediate land 22 in the axial direction A1. Therefore, traction performance can be effectively achieved.

The first notches 55 and the second notches 56 each have a shorter length in the axial direction than the first slits 51 and the second slits 52. The length of each of the first notches 55 and the second notches 56 is 5% or more and 15% or less of the length of the first shoulder land 24 in the axial direction. Since this value is set to 5% or more, the first notches 55 and the second notches 56 have sufficiently long edges, thereby achieving a sufficient traction effect. Since this value is set to 15% or less, the block rigidity is maintained at a high level, thereby reducing the likelihood of occurrence of uneven wear.

The width of each of the first notches 55 and the second notches 56 is 5% or more and 20% or less of the land width of the first shoulder land 24.

The first notches 55 and the second notches 56 each have a depth of 50% or more and 100% or less with respect to the main groove depth MD. For example, the depth of the first notches 55 is 60%, and the depth of the second notches 56 is 100%. Setting this value to 50% or more allows the first notches 55 and the second notches 56 to fulfill their traction performance even in the middle and late stages of wear.

### Sipes

The first shoulder land 24 has a plurality of sipes formed therein. The plurality of sipes make it possible to improve traction and lateral slip resistance while ensuring block rigidity. The depths of the plurality of sipes are relatively shallow to an extent that the sipes remain until the middle stage of tire wear to maintain winter performance, while maintaining block rigidity. The plurality of sipes include first axial sipes 61, second axial sipes 62, and circumferential sipes 63.

Each first axial sipe 61 extends in the axial direction A1 and divides a corresponding one of the first land constricted portions 53. Each second axial sipe 62 extends in the axial direction A1 and divides a corresponding one of the second land constricted portions 54. In the present embodiment, the first axial sipes 61 and the second axial sipes 62 have a serpentine shape on the tread surface in plan view when the tire is unused, but may have any shape, such as a straight shape. However, from the viewpoint of suppressing uneven wear, it is preferable that the first axial sipes 61 are configured as serpentine sipes rather than straight sipes because the serpentine sipes are more effective in suppressing movement of the land.

Each first axial sipe 61 extends in the first land constricted portion 53 and connects the first slit 51 and the first notch 55. Each second axial sipe 62 extends in the second land constricted portion 54 and connects the second slit 52 and the second notch 56. Each of the first axial sipes 61 and the second axial sipes 62 has, in its deepest portion, a depth of 60% or more and 90% or less of the main groove depth MD, and becomes deeper toward its center. Thus, the depth of each of the first axial sipes 61 and the second axial sipes 62 is shallow in the portion connected to the first shoulder main groove 13 so as to ensure block rigidity, and is deep in its center portion so as to suppress slipping and uneven wear.

The circumferential sipes 63 extend in the circumferential direction C1 in an axial center portion of the first shoulder land 24, and connect the first slits 51 and the second slits 52 that are alternately arranged in the circumferential direction C1. Specifically, the circumferential sipes 63 extend in the circumferential direction C1, each open to both the first slit 51 and the second slit 52, and divide the first shoulder land 24 into two portions adjacent in the axial direction A1. The circumferential sipes 63 have a serpentine shape on the tread surface. Therefore, the wall surfaces of each circumferential sipe 63 come into contact with each other, making it possible to suppress excessive movement of small blocks. The circumferential sipe 63 may be a three-dimensional sipe including a portion whose shape changes along the depth direction, or a two-dimensional sipe having a constant shape along the depth direction.

Each circumferential sipe 63 has, in its deepest portion, a depth of 60% or more and 90% or less of the main groove depth MD, and becomes deeper toward its center. Thus, the depth of the circumferential sipes 63 is shallow in the portion connected to the groove so as to ensure block rigidity, and is deep in its center portion so as to suppress lateral slipping and uneven wear.

The first shoulder land 24 is divided into two portions with the circumferential sipes 63 interposed as a boundary, namely an inner shoulder sub-land 64 that is an axially inner portion and an outer shoulder sub-land 65 that is an axially outer portion. In this case, the inner shoulder sub-land 64 has a ribbed shape and is continuous in the circumferential direction C1. The inner shoulder sub-land 64 and the outer shoulder sub-land 65 have substantially equal widths. Configuring the inner shoulder sub-land 64 as a ribbed shape as described above leads to an increase in rigidity and suppression of uneven wear (T/H).

The inner shoulder sub-land 64 is divided in the circumferential direction C1 by the first axial sipes 61 and the second axial sipes 62, thereby constituting a row of a plurality of inner shoulder sub-land blocks 71.

The outer shoulder sub-land 65 is divided in the circumferential direction C1 by the first slits 51 and the second slits 52, thereby constituting a row of a plurality of outer shoulder sub-land blocks 72.

Each inner shoulder sub-land block 71 has a one-side closed sipe 73 formed therein. The one-side closed sipe 73 is provided near the center between the first notch 55 and the second notch 56, opens to the first shoulder main groove 13, and is closed within the inner shoulder sub-land block 71. The one-side closed sipe 73 has a serpentine shape on the tread surface. It may have a straight shape on the tread surface. Further, the one-side closed sipe 73 may be a two-dimensional sipe having a constant shape along the depth direction, or a three-dimensional sipe including a portion whose shape changes along the depth direction. The one-side closed sipe 73 has a sipe depth of 10% or more and 30% or less of the main groove depth MD. If the sipe depth is less than 10%, the traction effect in the initial stage of wear will become insufficient, thereby increasing the likelihood of a decrease in ice performance. If the sipe depth is greater than 30%, block rigidity will decrease, thereby increasing the likelihood of occurrence of uneven wear.

Each inner shoulder sub-land block 71 further has a pair of two-side closed sipes 74 formed therein. The pair of two-side closed sipes 74 are provided on both circumferential sides of the one-side closed sipe 73. Each two-side closed sipe 74 has both ends closed within the inner shoulder sub-land block 71. Each two-side closed sipe 74 has a serpentine shape on the tread surface. Each two-side closed sipe 74 may have a straight shape on the tread surface. Each two-side closed sipe 74 may be a two-dimensional sipe having a constant shape along the depth direction, or a three-dimensional sipe including a portion whose shape changes along the depth direction. Each two-side closed sipe 74 has a sipe depth of 50% or more and 70% or less of the main groove depth MD. If the sipe depth is less than 50%, the traction effect will become insufficient, thereby increasing the likelihood of deterioration of winter performance. If the sipe depth is greater than 70%, block rigidity will decrease, thereby increasing the likelihood of occurrence of uneven wear.

Each outer shoulder sub-land block 72 has two-side closed sipes 75 formed therein. The two-side closed sipes 75 extend in the axial direction A1 and have both ends closed within the first shoulder land 24. The reason why only two-side closed sipes are provided in the outer shoulder sub-land blocks 72 is that the outer shoulder sub-land blocks 72 are provided close to the first ground contact end 15 and are easily affected by lateral force. The two-side closed sipes 75 have a serpentine shape on the tread surface. It may have a straight shape on the tread surface. Further, each two-side closed sipe 75 may be a two-dimensional sipes having a constant shape along the depth direction, or a three-dimensional sipe including a portion whose shape changes along the depth direction.

The two-side closed sipes 75 include three axial sipes 75a, 75b, and 75c that extend in the axial direction A1 and are arranged in the circumferential direction in this order.

The axial sipes 75a and 75c that are respectively disposed near opposite block edges, have lengths equal to or greater than that of the axial sipe 75b at a middle. The axial sipes 75a and 75c that are respectively disposed near the opposite block edges have a depth of 40% or more and 80% of the main groove depth MD. The middle axial sipe 75b has a depth of 5% or more and 30% or less of the main groove depth MD. This configuration, in which the axial sipes 75a and 75b disposed near the opposite block edges where slipping tends to increase are long and deep to suppress slipping, whereas the middle axial sipe 75c is short and shallow to ensure block rigidity, makes it possible to suppress uneven wear (T/H or shoulder wear).

Each of the second closed portions 52b includes a recess 58 at the axially outer edge of the inner shoulder sub-land 64, and constitutes a snow hole 59. Since the snow holes 59 are formed in the axial center portion of the first shoulder land 24 in this way, the snow column shear force can be increased during traveling on an ice and snow road, without excessively reducing the rigidity of the first shoulder land 24. Moreover, because each snow hole 59 is connected to the first shoulder main groove 13, the first ground contact end 15, and the first slit 51 via the second axial sipe 62, the circumferential sipe 63, and the second slit 52, snow in the snow hole 59 is smoothly removed as the tire 1 rolls, and the occurrence of snow clogging is suppressed. As a result, snow performance can be improved.

A ratio of the maximum circumferential length to the maximum axial length of each center land block 36 is represented by CeL/CeW. A ratio of the maximum circumferential length to the maximum axial length of each intermediate land block 46 is represented by MeL/MeW. A ratio of the maximum circumferential length to the maximum axial length of each of the inner shoulder sub-land blocks 71 and the outer shoulder sub-land blocks 72 is represented by ShL/ShW. In this case, CeL/CeW > MeL/MeW > ShL/ShW is satisfied.

The above configuration exerts the following effects. The center land blocks 36 of the center land 21 receive a high ground contact pressure and are susceptible to a force in the front-rear direction particularly at the time of driving, for example, and for this reason, CeL/CeW is set to be larger than MeL/MeW and ShL/ShW. The inner shoulder sub-land blocks 71 and the outer shoulder sub-land blocks 72 of the first shoulder land 24 and the second shoulder land 25 are susceptible to the influence of lateral force particularly at the time of turning, and for this reason, ShL/ShW is set to be smaller than CeL/CeW and Me. Setting MeL/MeW of the intermediate land blocks 46 to a value between CeL/CeW and ShL/ShW leads to improvement of the rigidity balance when the tire contacts with the ground, thereby making it possible to suppress the occurrence of uneven wear while ensuring winter performance.

### Second Embodiment

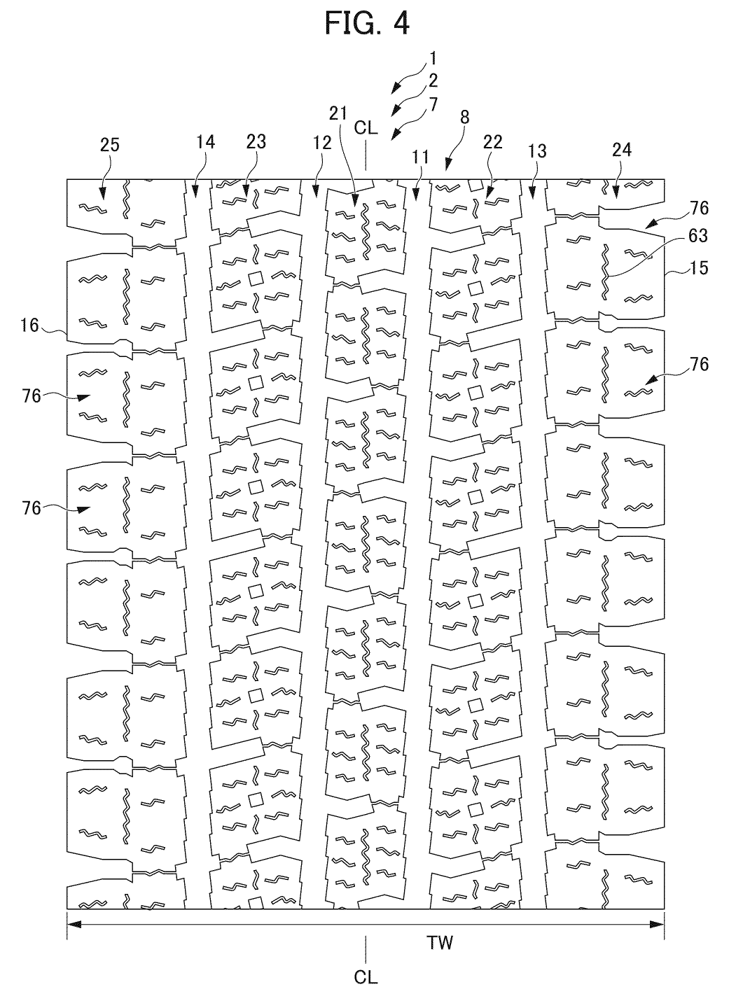

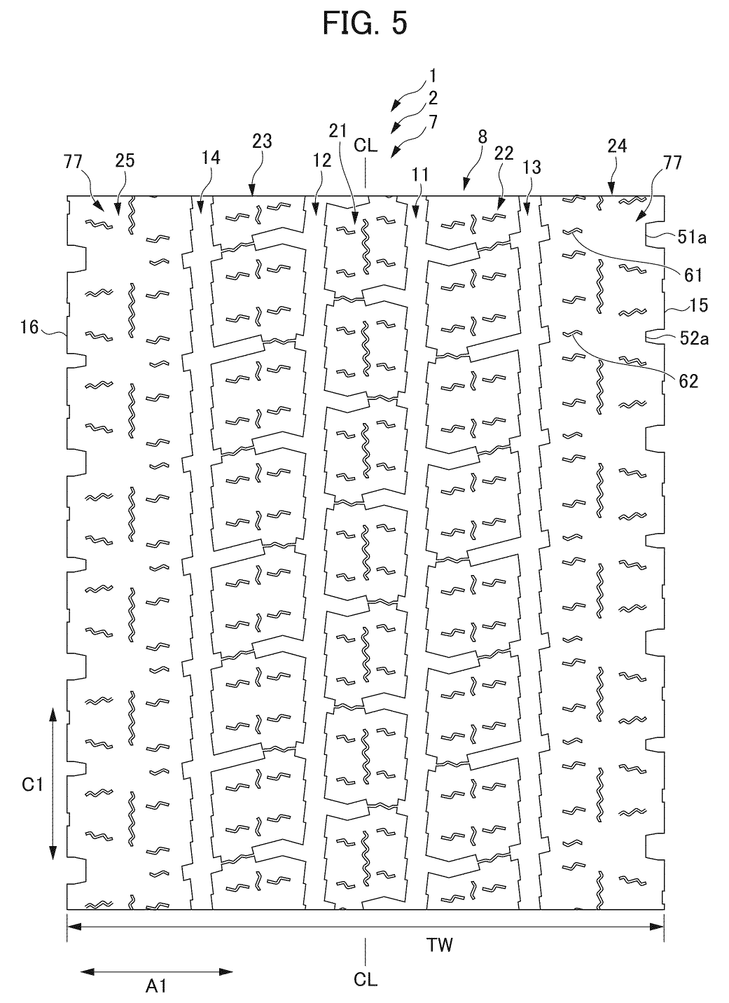

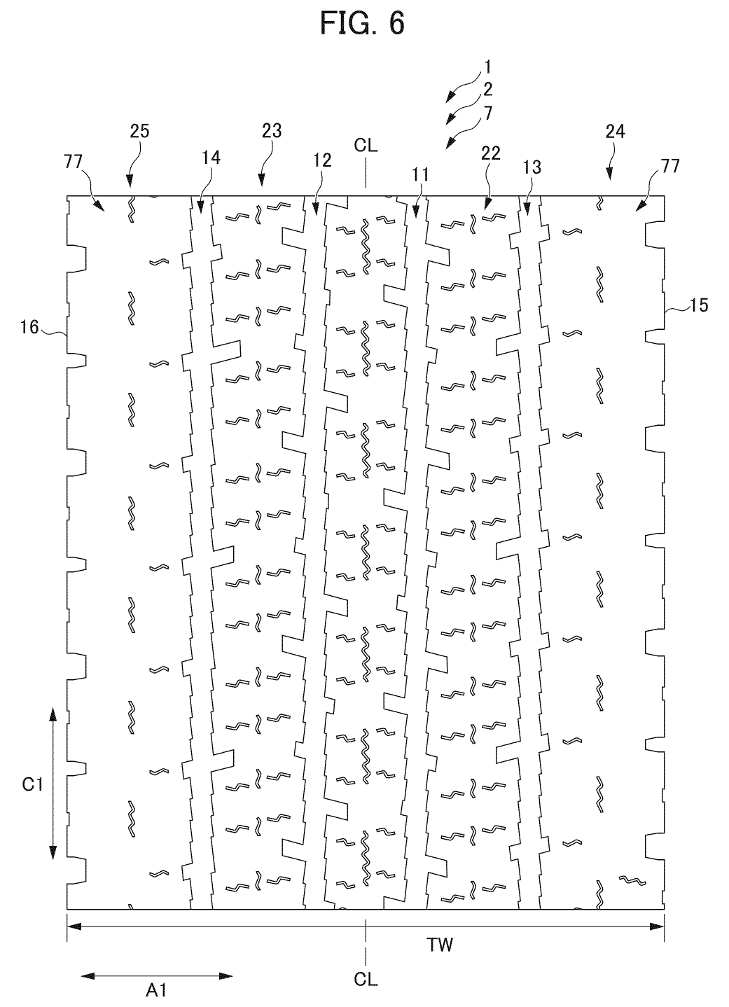

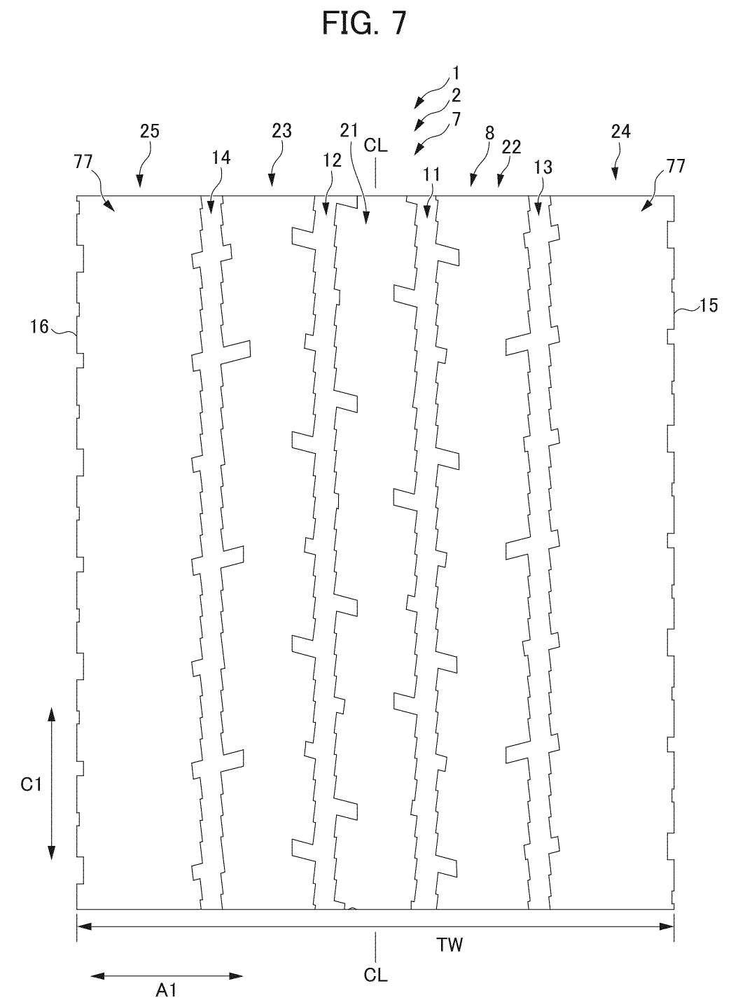

A second embodiment will be described with reference to FIGS. 1 to 3 and 4 to 7. FIG. 4 is a development view illustrating the tread surface 7 at 15% tire wear. FIG. 5 is a development view illustrating the tread surface 7 at 50% tire wear. FIG. 6 is a development view illustrating the tread surface 7 at 66% tire wear. FIG. 7 is a development view illustrating the tread surface 7 at 75% tire wear.

In the second embodiment, a ratio of change in a density of the shoulder land sipes at each stage of tire wear will be described. The basic configuration of the tire 1 of the second embodiment is the same as that of the first embodiment. However, the following features of the second embodiment are applicable to tires having different shapes.

As described in the first embodiment, uneven wear of the first shoulder land 24 is reduced by increasing the rigidity of the first shoulder land 24. In addition, in the second embodiment, the sipe density in the first shoulder land 24 is set as appropriate such that the sipes are maintained to a certain extent while suppressing uneven wear up to, for example, 50% wear, thereby making it possible to maintain winter performance.

A center land sipe density is a value obtained by dividing the sum of the lengths of the sipes in the center land 21 by the area of the center land 21. An intermediate land sipe density is a value obtained by dividing the sum of the lengths of the sipes in the first intermediate land 22 and the second intermediate land 23 by the sum of the the areas of the first intermediate land 22 and the second intermediate land 23. The shoulder land sipe density is a value obtained by dividing the sum of the lengths of the sipes in the first shoulder land 24 and the second shoulder land 25 by the sum of the area of the first shoulder land 24 and the second shoulder land 25.

At 15% wear illustrated in FIG. 4, in the first shoulder land 24, the axial sipes 75b and the one-side closed sipes 73 have been lost. Furthermore, in the first shoulder land 24, both ends of each of the circumferential sipes 63 have been lost. As a result, the adjacent inner shoulder sub-land block 71 and outer shoulder sub-land block 72 are connected to each other to form one block 76. At this stage, the shoulder land sipe density is 60% or more and 80% or less with respect to the shoulder land sipe density in an unused state in which the tire is unused. Since this value is 60% or more, the sipes exist in a sufficient amount, and high winter performance (ice performance and snow performance) is achieved. Since this value is 80% or less, high block rigidity is ensured, and uneven wear is less likely to occur.

At 50% wear illustrated in FIG. 5, in the first shoulder land 24, the first closed portions 51b and the first intermediate portions 51c of the first slits 51 have been lost, whereas the first opening portions 51a remain. The second closed portions 52b and the second intermediate portions 52c of the second slits 52 have been lost, whereas the second opening portions 52a remain. Furthermore, in the first shoulder land 24, both ends of each of the first axial sipes 61 and the second axial sipes 62 have been lost. As a result, the blocks 76 are connected to one another to form one rib 77. At this stage, the shoulder land sipe density is 35% or more and 55% or less with respect to the shoulder land sipe density in the unused state. Since this value is 35% or more, the slits exist in a sufficient amount, and high winter performance (ice performance and snow performance) is achieved. Since this value is 55% or less, high block rigidity is ensured, and uneven wear is less likely to occur.

At 66% wear illustrated in FIG. 6, in the first shoulder land 24, the two-side closed sipes 74, the axial sipes 75a, and the axial sipes 75c have been lost. In other words, the axial sipes have been lost inside the first shoulder land 24. Furthermore, in the center land 21, the first axial sipes 33 and the second axial sipes 34 have been lost. In the first intermediate land 22 and the second intermediate land 23, the first axial sipes 43 and the second axial sipes 44 have been lost.

At 75% wear illustrated in FIG. 7, all of the sipes have been lost.

As described above, uneven wear of the first shoulder land 24 is suppressed by increasing the rigidity of the first shoulder land 24. Furthermore, appropriately setting the number, lengths, and depths of the sipes allows for maintaining a certain amount of the sipes while suppressing uneven wear up to, for example, 50% wear, thereby making it possible to maintain winter performance.

### Third Embodiment

Similarly to the second embodiment, a third embodiment will be described with reference to FIGS. 1 to 7.

In the third embodiment, an amount of change in the shoulder land sipe density at each stage of tire wear will be described. The basic configuration of the tire 1 of the third embodiment is the same as that of the first embodiment. However, the following features of the third embodiment are applicable to tires having different shapes.

As described in the first embodiment, uneven wear of the first shoulder land 24 is reduced by increasing the rigidity of the first shoulder land 24. In addition, in the third embodiment, the sipe density of the first shoulder land 24 is set as appropriate such that the sipes are maintained to a certain extent while suppressing uneven wear up to, for example, 50% wear, thereby making it possible to maintain winter performance.

When the tire is in an unused state illustrated in FIG. 1, the shoulder land sipe density is 0.055 mm/mm² or more and 0.075 mm/mm² or less. Since this value is 0.055 mm/mm² or more, the sipes exist in a sufficient amount, and high winter performance (ice performance and snow performance) is achieved. Since this value is 0.075 mm/mm² or less, high block rigidity is ensured, and uneven wear is less likely to occur.

At 15% wear illustrated in FIG. 4, the shoulder land sipe density is 0.035 mm/mm² or more and 0.055 mm/mm² or less. Since this value is 0.035 mm/mm² or more, the sipes exist in a sufficient amount, and sufficiently high winter performance (ice performance and snow performance) is achieved. Since this value is 0.055 mm/mm² or less, sufficiently high block rigidity is ensured, and uneven wear is less likely to occur.

At 50% wear illustrated in FIG. 5, the shoulder land sipe density is 0.020 mm/mm² or more and 0.040 mm/mm² or less. Since this value is 0.020 mm/mm² or more, the sipes exist in a sufficient amount, and sufficiently high winter performance (ice performance and snow performance) is achieved. Since this value is 0.040 mm/mm² or less, high block rigidity is ensured, and uneven wear is less likely to occur.

### Fourth Embodiment

Similarly to the third embodiment, a fourth embodiment will be described using FIGS. 1 to 7.

In the fourth embodiment, a ratio of the shoulder land sipe density to the center land sipe density and the intermediate land sipe density at each stage of tire wear will be described. The basic configuration of the tire 1 of the fourth embodiment is the same as that of the first embodiment. However, the following features of the fourth embodiment are applicable to tires having different shapes.

As described in the first embodiment, uneven wear of the first shoulder land 24 is reduced by increasing the rigidity of the first shoulder land 24. In addition, in the fourth embodiment, the ratio of the shoulder land sipe density to the center land sipe density and the intermediate land sipe density is set as appropriate such that the sipes are maintained to a certain extent while suppressing uneven wear up to, for example, 50% wear, thereby making it possible to maintain winter performance.

The shoulder land sipe density is smaller than the center land sipe density and the intermediate land sipe density.

When the tire is in the unused state illustrated in FIG. 1, the shoulder land sipe density is 70% or more and 90% or less with respect to the average value of the center land sipe density and the intermediate land sipe density. Since this value is 70% or more, the sipes exist in a sufficient amount, and sufficiently high winter performance (ice performance and snow performance) is achieved. Since this value is 90% or less, high block rigidity is ensured, and uneven wear is less likely to occur.

At 15% wear illustrated in FIG. 4, the shoulder land sipe density is 55% or more and 75% or less with respect to the average value of the center land sipe density and the intermediate land sipe density. Since this value is 55% or more, the sipes exist in a sufficiently amount, and sufficiently high winter performance (ice performance and snow performance) is achieved. Since this value is 75% or less, high block rigidity is ensured, and uneven wear is less likely to occur.

At 50% wear illustrated in FIG. 5, the shoulder land sipe density is 50% or more and 70% or less with respect to the average value of the center land sipe density and the intermediate land sipe density. Since this value is 50% or more, the sipes exist in a sufficient amount, and sufficiently high winter performance (ice performance and snow performance) is achieved. Since this value is 70% or less, high block rigidity is ensured, and uneven wear is less likely to occur.

Aspects of the Present Invention
1. A pneumatic tire 1 having a tread 2,
the tread 2 including:
four main grooves extending in a circumferential direction C1; and
lands defined in a tire axial direction by the four main grooves, the lands including a center land 21, a first shoulder land 24, a second shoulder land 25, a first intermediate land 22 between the center land 21 and the first shoulder land 24, and a second intermediate land 23 between the center land 21 and the second shoulder land 25,
the first shoulder land 24 including:
a plurality of first slits 51 that each extend from a first ground contact end 15 of the tread 2, pass through a land width center, and reach a location inward in the tire axial direction;
a plurality of second slits 52 that are alternately arranged with the plurality of first slits 51 in the circumferential direction and extend inward in the tire axial direction from the ground contact end 15 of the tread 2, the plurality of second slits 52 having a narrower groove width than the plurality of first slits 51;
a plurality of first land constricted portions 53 that are provided inward in the tire axial direction with respected to the first slits 51 and are narrower than a maximum width of the first shoulder land 24;
a plurality of second land constricted portions 54 that are provided inward in the tire axial direction with respect to the second slits 52;
a plurality of first notches 55 that open to a first shoulder main groove 13 and are arranged such that the plurality of first land constricted portions 53 are interposed between the plurality of first notches 55 and the plurality of first slits 51; and
a plurality of second notches 56 that open to the first shoulder main groove 13 and are arranged such that the plurality of second land constricted portions 54 are interposed between the plurality of second notches 56 and the plurality of second slits 52.

This feature makes it possible to provide the pneumatic tire 1 that can maintain winter performance while suppressing uneven wear of the first shoulder land 24. Specifically, the first shoulder land 24, which is most susceptible to lateral force, is divided by the first slits 51 and the second slits 52 to mitigate the lateral force, thereby suppressing uneven wear. Furthermore, alternately arranging the first slits 51 having a large width and the second slits 52 having a narrow width allows for not only attaching a tire chain, but also ensuring block rigidity. Furthermore, configuring the axially inner portion of the first shoulder land 24 to have a ribbed shape leads to an increase in rigidity and suppression of uneven wear (T/H). Furthermore, the first notches 55 and the second notches 56 reliably serve as traction elements that are necessary for a studless winter tire to achieve winter performance.

2. In the pneumatic tire 1 described in (1),
each of the plurality of first slits 51 includes:
a first opening portion 51a that widens toward the first ground contact end 15;
a first closed portion 51b that is closed at a center of the first shoulder land 24; and
a first intermediate portion 51c that connects the first opening portion 51a and the first closed portion 51b, each of the plurality of second slits 52 includes:
a second opening portion 52a that widens toward the first ground contact end 15;
a second closed portion 52b that is closed at the center of the first shoulder land 24; and
a second intermediate portion 52c that connects the second opening portion 52a and the second closed portion 52b, and
the second closed portion 52b has a larger width in the tire circumferential direction than the second intermediate portion 52c.

Since the second closed portion 52b of the second slit 52 is wide as described above, snow is more easily gripped, and snow performance is improved. Furthermore, since the second intermediate portion 52c is wide, for example, adjacent blocks are brought into contact with each other at the time of braking, thereby suppressing excessive deformation of the blocks. As a result, occurrence of uneven wear can be suppressed.

3. In the pneumatic tire 1 described in (2),
the first closed portion 51b and the second closed portion 52b extend in a direction inclined toward one side in the circumferential direction C1 with respect to the axial direction A1.

The first closed portion 51b and the second closed portion 52b that are inclined in the same direction as described above lead to reduction or elimination of rigidity differences between the blocks, thereby suppressing occurrence of uneven wear.

4. In the pneumatic tire 1 described in any one of (1) to (3),
the first shoulder land 24 includes:
first axial sipes 61 that extend in the axial direction A1 and each divide a corresponding one of the first land constricted portions 53 in the circumferential direction C1; and
second axial sipes 62 that extend in the axial direction A1 and each divide a corresponding one of the second land constricted portions 54 in the circumferential direction C1.

Providing the first axial sipes 61 and the second axial sipes 62 described above makes it possible to improve traction performance and lateral slip resistance while ensuring block rigidity.

5. In the pneumatic tire 1 described in any one of (1) to (4),
the first shoulder land 24 includes circumferential sipes 63 that extend in the circumferential direction C1 in a portion near the center in the tire axial direction of the first shoulder land 24 and that connect the first slits 51 and the second slits 52.

Providing the circumferential sipes 63 described above makes it possible to improve traction performance and lateral slip resistance while ensuring block rigidity.

6. In the pneumatic tire described in any one of (1) to (5),
the first shoulder land 24 has, in the tire axial direction, a length of 10% or more and 30% or less with respect to a tread ground contact width TW of the tread 2.

Since the above value is 10% or more, the shoulder land has high rigidity, and uneven wear is less likely to occur. Since the above value is 30% or less, the center land and the intermediate lands have high rigidity, and uneven wear is less likely to occur.

7. In the pneumatic tire 1 described in any one of (1) to (6), the first slits 51 and the second slits 52 each have a length of 50% or more and 65% or less of the length of the first shoulder land 24 in the axial direction A1.

Since the above value is 50% or more, the effect of mitigating lateral force is maintained, and uneven wear (shoulder wear) is less likely to occur. Since the above value is 65% or less, block rigidity is maintained at a high level, and therefore uneven wear (T/H) and early wear are less likely to occur.

8. In the pneumatic tire 1 described in any one of (1) to (7), the first notches 55 and the second notches 56 have a length of 5% or more and 15% or less of the length of the first shoulder land 24 in the axial direction A1.

Since the above value is 5% or more, the notches have sufficiently long edges, and sufficient traction effect is achieved. Since the above value is 15% or less, block rigidity is maintained at a high level, and therefore uneven wear is less likely to occur.

9. In the pneumatic tire 1 described in any one of (1) to (8),
in each of the first slits 51, the first opening portion 51a is deeper than the first intermediate portion 51c,
in each of the second slits 52, the second opening portion 52a is deeper than the second intermediate portion 52c, and
the first closed portion 51b and the first intermediate portion 51c of each of the first slits 51 and the second closed portion 52b and the second intermediate portion 52c of each of the second slits 52 respectively have a depth of 40% or more and 60% or less with respect to a main groove depth MD of the first shoulder main groove 13.

Due to this feature, the first slits 51 and the second slits 52 have a depth sufficient up to the middle stage of wear and necessary for achieving winter performance, thereby making it possible to ensure block rigidity and suppress uneven wear. Since the above value is 40% or more, a sufficient volume for gripping snow can be ensured, thereby making it possible to maintain snow performance at a high level. Since the above value is 60% or less, block rigidity is ensured, and uneven wear is suppressed.

10. In the pneumatic tire 1 described in any one of (1) to (9), the first notches 55 and the second notches 56 each have a depth of 50% or more and 100% or less with respect to the main groove depth MD of the first shoulder main groove 13.

Since the above value is 50% or more, the first notches 55 and the second notches 56 can fulfill their traction performance even in the middle and late stages of wear.

11. In the pneumatic tire 1 described in any one of (1) to (10),
the center land 21 includes a plurality of center land blocks 36, and a ratio of a maximum circumferential length to a maximum axial length of each of the plurality of center land blocks 36 is represented as CeL/CeW,
the first intermediate land 22 and the second intermediate land 23 include a plurality of intermediate land blocks 46, and a ratio of a maximum circumferential length to a maximum axial length of each of the plurality of intermediate land blocks 46 is represented as MeL/MeW,
the first shoulder land 24 includes a plurality of inner shoulder sub-land blocks 71 and outer shoulder sub-land blocks 72, and a ratio of a maximum circumferential length to a maximum axial length of each of the plurality of inner shoulder sub-land blocks 71 and outer shoulder sub-land blocks 72 is represented as ShL/ShW, and
CeL/CeW > MeL/MeW > ShL/ShW is satisfied.

Since the center land blocks 36 of the center land 21 receive a high ground contact pressure and are susceptible to a force in the front-rear direction particularly at the time of driving, for example, and for this reason, CeL/CeW is set to be larger than MeL/MeW and ShL/ShW. The inner shoulder sub-land blocks 71 and the outer shoulder sub-land blocks 72 of the first shoulder land 24 and the second shoulder land 25 are particularly susceptible to a lateral force at the time of turning, for example, and for this reason, ShL/ShW is set to be smaller than CeL/CeW and Me. Setting MeL/MeW of the intermediate land blocks 46 to a value between CeL/CeW and ShL/ShW leads to improvement of rigidity balance when the tire contacts with the ground, thereby making it possible to suppress the occurrence of uneven wear while ensuring winter performance.

12. In the pneumatic tire described in any one of (1) to (11),
the first shoulder land 24 includes a plurality of inner shoulder sub-land blocks 71 and a plurality of outer shoulder sub-land blocks 72,
each of the plurality of outer shoulder sub-land blocks 72 has three axial sipes 75a, 75b, 75c extending in the axial direction A1 and arranged in the circumferential direction C1,
each of the three axial sipes 75a, 75b, 75c is closed at both ends thereof, and
among the three axial sipes, the axial sipes 75a, 75c disposed near opposite block edges of the outer shoulder sub-land block 72 have a length equal to or longer than that of the axial sipe 75b at a middle.

Forming the middle axial sipes 75b having a shorter length in the first shoulder land 24 as described above, block rigidity is ensured, and the occurrence of uneven wear is suppressed.

13. In the pneumatic tire described in (12), each of the axial sipes 75a, 75c that are respectively disposed near the opposite block edges of the outer shoulder sub-land block 72 has a depth of 40% or more and 80% or less of the main groove depth MD of the first shoulder main groove 13, and
the middle axial sipe 75b has a depth of 5% or more and 30% or less of the main groove depth MD of the first shoulder main groove 13.

The above feature, in which the sipes in portions where slipping tends to increase are long and deep to suppress slipping whereas the middle sipe is short and shallow, makes it possible to ensure block rigidity is secured and suppression of uneven wear (T/H and shoulder wear).

14. A tire 1 includes:
a tread 2,
the tread 2 including:
four main grooves extending in a circumferential direction C1; and
lands defined in a tire axial direction by the four main grooves, the lands including a center land 21, a first shoulder land 24, a second shoulder land 25, a first intermediate land 22 between the center land 21 and the first shoulder land 24, and a second intermediate land 23 between the center land 21 and the second shoulder land 25,
the shoulder lands having sipes. A shoulder land sipe density, which is a value obtained by dividing a sum of lengths of the sipes in the shoulder lands by a sum of areas of the shoulder lands, is defined as 100% in an unused state in which the tire is unused,
when a tire surface is worn by 15% with respect to a depth of the four main grooves (11, 12, 13, 14) that is defined as 100% in the unused state, the shoulder land sipe density is 60% or more and 80% or less with respect to the shoulder land sipe density in the unused state, and
when the tire surface is worn by 50% with respect to the depth of the four main grooves (11, 12, 13, 14) that is defined as being 100% in the unused state, the shoulder land sipe density is 35% or more and 55% or less with respect to the shoulder land sipe density in the unused state.

This feature makes it possible to provide the pneumatic tire 1 capable of maintaining winter performance while suppressing uneven wear of the first shoulder land 24. Specifically, since the above value is 60% or more at 15% wear, the sipes exist in a sufficient amount, and high winter performance (ice performance and snow performance) is achieved. Since the above value is 80% or less, high block rigidity is ensured, and uneven wear is less likely to occur. Furthermore, since the above value is 35% or more at 50% wear, the sipes exist in a sufficient amount, and high winter performance (ice performance and snow performance) is achieved. Since the above value is 55% or less, high block rigidity is ensured, and uneven wear is less likely to occur. As a result of the foregoing, in the tire 1 of the present embodiment, block rigidity, traction, and lateral slip resistance elements are well balanced, and uneven wear resistance can be improved while maintaining winter performance (ice performance and snow performance).

15. A tire 1 includes:
a tread 2,
the tread 2 including:
four main grooves extending in a circumferential direction C1;
lands defined in a tire axial direction by the four main grooves, the lands including a center land 21, a first shoulder land 24, a second shoulder land 25, a first intermediate land 22 between the center land 21 and the first shoulder land 24, and a second intermediate land 23 between the center land 21 and the second shoulder land 25,
the first shoulder land 24 and the second shoulder land 25 having sipes,
a shoulder land sipe density, which is a value obtained by dividing a sum of lengths of the sipes in the first shoulder land 24 and the second shoulder land 25 by a sum of areas of the first shoulder land 24 and the second shoulder land 25, is:
0.055 mm/mm² or more and 0.075 mm/mm² or less in an unused state in which the pneumatic tire is unused,
0.035 mm/mm² or more and 0.055 mm/mm² or less when a tire surface is worn by 15% with respect to a depth of the four main grooves (11, 12, 13, 14) that is defined as 100% in the unused state, and
0.020 mm/mm² or more and 0.040 mm/mm² or less when the tire surface is worn by 50% with respect to the depth of the four main grooves (11, 12, 13, 14) that is defined as 100% in the unused state.

This feature makes it possible to provide the pneumatic tire 1 capable of maintaining winter performance while suppressing uneven wear of the first shoulder land 24. Specifically, since the above value is 0.035 mm/mm² or more at 15% wear, the sipes exist in a sufficient amount, and high winter performance (ice performance and snow performance) is achieved. Since the above value is 0.055 mm/mm² or less, high block rigidity is ensured, and uneven wear is less likely to occur. Furthermore, since the above value is 0.020 mm/mm² or more at 50% wear, the sipes exist in a sufficient amount, and sufficiently high winter performance (ice performance and snow performance) is achieved. Since the above value is 0.040 mm/mm² or less, high block rigidity is ensured, and uneven wear is less likely to occur.

16. In the pneumatic tire described in (14) or (15),
each of the center land 21, the first shoulder land 24, the second shoulder land 25, the first intermediate land 22 and the second intermediate land 23 has sips,
with respect to an average value of a center land sipe density obtained by dividing a sum of lengths of the sipes in the center land 21 by an area of the center land 21 and an intermediate land sipe density obtained by dividing a sum of lengths of the sipes in the first and second intermediate lands 22, 23 by a sum of areas of the first and second intermediate lands 22, 23, the shoulder land sipe density obtained by dividing a sum of lengths of the sipes in the first and second shoulder lands 24, 25 by a sum of areas of the first and second shoulder lands 24, 25 is:
70% or more and 90% or less in the unused state,
55% or more and 75% or less when a tire surface is worn by 15% with respect to a depth of the four main grooves (11, 12, 13, 14) that is defined as 100% in the unused state, and
50% or more and 70% or less when a tire surface is worn by 50% with respect to the depth of the four main grooves (11, 12, 13, 14) that is defined as 100% in the unused state.

This feature makes it possible to provide the pneumatic tire 1 capable of maintaining winter performance while suppressing uneven wear of the first shoulder land 24.
Specifically, since the above value is 55% or more at 15% wear, the sipes exist in a sufficient amount, and sufficiently high winter performance (ice performance and snow performance) is achieved. Since the above value is 75% or less, high block rigidity is ensured, and uneven wear is less likely to occur. Furthermore, since the above value is 50% or more at 50% wear, the sipes exist in a sufficient amount, and sufficiently high winter performance (ice performance and snow performance) is achieved. Since the above value is 70% or less, high block rigidity is ensured, and uneven wear is less likely to occur.

17. In the pneumatic tire described in any one of (14) to (16), the first shoulder land 24 has, in the tire axial direction, a length of 10% or more and 30% or less with respect to a tread ground contact width TW of the tread 2.

Since the above value is 10% or more, the shoulder land has high rigidity, and uneven wear is less likely to occur. Since the above value is 30% or less, the center land and the intermediate lands have high rigidity, and uneven wear is less likely to occur.

18. In the pneumatic tire described in any one of (14) to (17), the center land 21 includes a plurality of center land blocks 36, and a ratio of a maximum circumferential length to a maximum axial length of each of the plurality of center land blocks 36 is represented as CeL/CeW,
the first intermediate land 22 and the second intermediate land 23 include a plurality of intermediate land blocks 46, and a ratio of a maximum circumferential length to a maximum axial length of each of the plurality of intermediate land blocks 46 is represented as MeL/MeW,
the first shoulder land 24 includes a plurality of inner shoulder sub-land blocks 71 and outer shoulder sub-land blocks 72, and a ratio of a maximum circumferential length to a maximum axial length of each of the plurality of inner shoulder sub-land blocks 71 and outer shoulder sub-land blocks 72 is represented as ShL/ShW, and
CeL/CeW > MeL/MeW > ShL/ShW is satisfied.

Since the center land blocks 36 of the center land 21 receive a high ground contact pressure and are susceptible to a force in the front-rear direction particularly at the time of driving, for example, and for this reason, CeL/CeW is set to be larger than MeL/MeW and ShL/ShW. The inner shoulder sub-land blocks 71 and the outer shoulder sub-land blocks 72 of the first shoulder land 24 and the second shoulder land 25 are particularly susceptible to a lateral force at the time of turning, for example, and for this reason, ShL/ShW is set to be smaller than CeL/CeW and Me. Setting MeL/MeW of the intermediate land blocks 46 to a value between CeL/CeW and ShL/ShW leads to improvement of the rigidity balance when the tire contacts with the ground contact, thereby making it possible to suppress the occurrence of uneven wear while ensuring winter performance.

Although several embodiments of the present invention have been described, the present invention is not limited to the above-described embodiments, and various modifications can be made without departing from the spirit of the present invention. In particular, the embodiments and modifications described in the present specification can be arbitrarily combined as necessary.

### EXPLANATION OF REFERENCE NUMERALS

1: Pneumatic tire
2: Tread
7: Tread surface
8: Tread pattern
11: First center main groove
12: Second center main groove
13: First shoulder main groove
14: Second shoulder main groove
15: First ground contact end
16: Second ground contact end
21: Center land
22: First intermediate land
23: Second intermediate land
24: First shoulder land
25: Second shoulder land
36: Center land block
46: Intermediate land block
51: First slit
51a: First opening portion
51b: First closed portion
51c: First intermediate portion
52: Second slit
52a: Second opening portion
52b: Second closed portion
52c: Second intermediate portion
53: First land constricted portion
54: Second land constricted portion
55: First notch
56: Second notch
61: First axial sipe
62: Second axial sipe
63: Circumferential sipe
64: Inner shoulder sub-land
65: Outer shoulder sub-land
71: Inner shoulder sub-land block
72: Outer shoulder sub-land block
73: One-side closed sipe
74: Two-side closed sipe
75: Two-side closed sipe
75a: Axial sipe
75b: Axial sipe
75c: Axial sipe
A1: Axial direction
C1: Circumferential direction
CL: Tire equatorial plane
MD: Main groove depth
TW: Ground contact width of tread

What is claimed is:

1. A pneumatic tire comprising: a tread,
the tread including:
four main grooves extending in a tire circumferential direction; and
lands defined in a tire axial direction by the four main grooves, the lands including a center land, a pair of shoulder lands, and a pair of intermediate lands one of which is disposed between the center land and one of the pair of shoulder lands, and the other of which is disposed between the center land and the other of the pair of shoulder lands,
each of the pair of shoulder lands including:
a plurality of first slits that each extend from a ground contact end of the tread, pass through a land width center, and reach a location inward in the tire axial direction;
a plurality of second slits that are arranged alternately with the plurality of first slits in the tire circumferential direction, and extend inward in the tire axial direction from the ground contact end of the tread, the plurality of second slits having a narrower groove width than the plurality of first slits;
a plurality of first land constricted portions that are provided inward in the tire axial direction with respect to the first slits and are shorter than a maximum width of the shoulder land;
a plurality of second land constricted portions that are provided inward in the tire axial direction with respect to the second slits;
a plurality of first notches that open to one of the main grooves and are arranged such that the plurality of first land constricted portions are interposed between the plurality of first notches and the plurality of first slits; and
a plurality of second notches that open to the one of the main grooves and are arranged such that the plurality of second land constricted portions are interposed between the plurality of second notches and the plurality of second slits.

2. The pneumatic tire according to claim 1, wherein
each of the plurality of first slits includes:
a first opening portion that widens toward the ground contact end;
a first closed portion that is closed at a center of the shoulder land; and
a first intermediate portion that connects the first opening portion and the first closed portion,
each of the plurality of second slits includes:
a second opening portion that widens toward the ground contact end;
a second closed portion that is closed at the center of the shoulder land; and
a second intermediate portion that connects the second opening portion and the second closed portion, and
the second closed portion has a larger width in the tire circumferential direction than the second intermediate portion.

3. The pneumatic tire according to claim 2, wherein the first closed portion and the second closed portion extend in a direction inclined toward one side in the tire circumferential direction with respect to the tire axial direction.

4. The pneumatic tire according to claim 1, wherein each of the pair of shoulder lands further includes:
first axial sipes that extend in the tire axial direction and each divide a corresponding one of the first land constricted portions in the tire circumferential direction; and
second axial sipes that extend in the tire axial direction and each divide a corresponding one of the second land constricted portions in the tire circumferential direction.

5. The pneumatic tire according to claim 1, wherein each of the pair of the shoulder lands further includes circumferential sipes that extend in the tire circumferential direction in a portion near a center in the tire axial direction of the shoulder land and that connect the first slits and the second slits.

6. The pneumatic tire according to claim 1, wherein each of the pair of the shoulder lands further has, in the tire axial direction, a length of 10% to 30% with respect to a ground contact width of the tread.

7. The pneumatic tire according to claim 1, wherein the first slits and the second slits each have a length of 50% to 65% of a length of each of the pair of shoulder lands in the tire axial direction.

8. The pneumatic tire according to claim 1, wherein the first notches and the second notches each have a length of 5% to 15% of a length of each of the pair of shoulder lands in the tire axial direction.

9. The pneumatic tire according to claim 2, wherein
in each of the first slits, the first opening portion is deeper than the first intermediate portion,
in each of the second slits, the second opening portion is deeper than the second intermediate portion, and
the first closed portion and the first intermediate portion of each of the first slits and the second closed portion and the second intermediate portion of each of the second slits respectively have a depth of 40% to 60% with respect to a depth of the main grooves.

10. The pneumatic tire according to claim 1, wherein the first notches and the second notches each have a depth of 50% to 100% with respect to a depth of the main grooves.

11. The pneumatic tire according to claim 1, wherein
the center land includes a plurality of center land blocks, and a ratio of a maximum circumferential length to a maximum axial length of each of the plurality of center land blocks is represented as CeL/CeW,
the pair of intermediate lands include a plurality of intermediate land blocks, and a ratio of a maximum circumferential length to a maximum axial length of each of the plurality of intermediate land blocks is represented as MeL/MeW,
the pair of shoulder lands include a plurality of shoulder land blocks, and a ratio of a maximum circumferential length to a maximum axial length of each of the plurality of shoulder land blocks is represented as ShL/ShW, and
CeL/CeW > MeL/MeW > ShL/ShW is satisfied.

12. The pneumatic tire according to claim 1, wherein
the pair of shoulder lands each includes a plurality of inner shoulder sub-land blocks and a plurality of outer shoulder sub-land blocks,
each of the plurality of outer shoulder sub-land blocks has three axial sipes extending in the tire axial direction and arranged in the tire circumferential direction,
each of the three axial sipes is closed at both ends thereof, and
among the three axial sipes, the axial sipes that are respectively disposed near opposite block edges of the outer shoulder sub-land block have a length equal to or longer than a length of the axial sipe at a middle.

13. The pneumatic tire according to claim 12, wherein
each of the axial sipes that are respectively disposed near the opposite block edges of the outer shoulder sub-land block has a depth of 40% to 80% of a depth of the main grooves, and
the axial sipe at the middle has a depth of 5% to 30% of the depth of the main grooves.

14. A pneumatic tire comprising: a tread,
the tread including:
four main grooves extending in a tire circumferential direction; and
lands defined in a tire axial direction by the four main grooves, the lands including a center land, a pair of shoulder lands, and a pair of intermediate lands one of which is disposed between the center land and one of the pair of shoulder lands, and the other of which is disposed between the center land and the other of the pair of shoulder lands,
the shoulder lands including sipes, wherein
a shoulder land sipe density, which is a value obtained by dividing a sum of lengths of the sipes in the shoulder lands by a sum of areas of the shoulder lands, is defined as 100% in an unused state in which the pneumatic tire is unused,
when a tire surface is worn by 15% with respect to a depth of the main grooves that is defined as 100% in the unused state, the shoulder land sipe density is 60% or more and 80% or less with respect to the shoulder land sipe density in the unused state, and
when the tire surface is worn by 50% with respect to the depth of the main grooves that is defined as 100% in the unused state, the shoulder land sipe density is 35% or more and 55% or less with respect to the shoulder land sipe density in the unused state.

15. A pneumatic tire comprising: a tread,
the tread including:
four main grooves extending in a tire circumferential direction; and
lands defined in a tire axial direction by the four main grooves, the lands including a center land, a pair of shoulder lands, and a pair of intermediate lands one of which is disposed between the center land and one of the pair of shoulder lands, and the other of which is disposed between the center land and the other of the pair of shoulder lands,
the shoulder lands including sipes, wherein
a shoulder land sipe density, which is a value obtained by dividing a sum of lengths of the sipes in the shoulder lands by a sum of areas of the shoulder lands, is:
150.055 mm/mm² or more and 0.075 mm/mm² or less in an unused state in which the pneumatic tire is unused;
150.035 mm/mm² or more and 0.055 mm/mm² or less when a tire surface is worn by % with respect to a depth of the main grooves that is defined as 100% in the unused state; and
150.020 mm/mm² or more and 0.040 mm/mm² or less when the tire surface is worn by 50% with respect to the depth of the main grooves that is defined as 100% in the unused state.

16. The pneumatic tire according to claim 14, wherein
each of the center land, the shoulder lands, and the intermediate lands includes sipes,
with respect to an average value of a center land sipe density obtained by dividing a sum of lengths of the sipes in the center land by an area of the center land, and an intermediate land sipe density obtained by dividing a sum of lengths of the sipes in the intermediate lands by a sum of areas of the intermediate lands, the shoulder land sipe density is:
70% to 90% in the unused state;
55% to 75% when the tire surface is worn by 15% with respect to the depth of the main grooves that is defined as 100% in the unused state; and
50% to 70% when the tire surface is worn by 50% with respect to the depth of the main grooves that is defined as 100% in the unused state.

17. The pneumatic tire according to claim 14, wherein each of the shoulder lands has a land width of 10% to 30% with respect to a ground contact width of the tread.

18. The pneumatic tire according to claim 14, wherein
the center land includes a plurality of center land blocks, and a ratio of a maximum circumferential length to a maximum axial length of each of the plurality of center land blocks is represented as CeL/CeW,
the intermediate lands include a plurality of intermediate land blocks, and a ratio of a maximum circumferential length to a maximum axial length of each of the plurality of intermediate land blocks is represented as MeL/MeW,
the shoulder lands include a plurality of shoulder land blocks, and a ratio of a maximum circumferential length to a maximum axial length of each of the plurality of shoulder land blocks is represented as ShL/ShW, and
CeL/CeW > MeL/MeW > ShL/ShW is satisfied.

19. The pneumatic tire according to claim 15, wherein
each of the center land, the shoulder lands, and the intermediate lands includes sipes,
with respect to an average value of a center land sipe density obtained by dividing a sum of lengths of the sipes in the center land by an area of the center land, and an intermediate land sipe density obtained by dividing a sum of lengths of the sipes in the intermediate lands by a sum of areas of the intermediate lands, the shoulder land sipe density is:
70% to 90% in the unused state;
55% to 75% when the tire surface is worn by 15% with respect to the depth of the main grooves that is defined as 100% in the unused state; and
50% to 70% when the tire surface is worn by 50% with respect to the depth of the main grooves that is defined as 100% in the unused state.

20. The pneumatic tire according to claim 15, wherein each of the shoulder lands has a land width of 10% to 30% with respect to a ground contact width of the tread.
